(19) United States
(12) Patent Application Publication
(10) Pub. No.: US 2002/0195025 A1
(43) Pub. Date: Dec. 26, 2002

(54) Building materials employing powder compositions as rheological additives

(76) Inventors: Andreas Bacher, Burghausen (DE); Werner Bauer, Winhoering (DE); Ulf Dietrich, Burghausen (DE); Bernd Kayser, Neubiberg (DE); Marion Schmitz, Burghausen (DE); Harald Zeh, Burghausen (DE); Theo Mayer, Julbach (DE)

Correspondence Address: WILLIAM G. CONGER, Brooks & Kushman P.C., 22nd Floor, 1000 Town Center, Southfield, MI, 48075-1351, US

(21) Appl. No.: 10/143,338

(22) Filed: May 9, 2002

(30) Foreign Application Priority Data
May 10, 2001 (DE) 101 22 629.2

(51) Int. Cl. C04B 11/00; C04B 28/14; C04B 2/02; C04B 16/00; C04B 24/00

(52) U.S. Cl. 106/778; 106/803; 106/795

(57) ABSTRACT

Cement-containing or cement-free building material compositions containing a pulverulent rheological additive comprising: a) soluble a copolymer of (meth)acrylic acid and (meth)acrylic esters, b) a dispersant, and c) a polymer powder which is redispersible in water provide mortars, adhesives, grouts, etc., with excellent processability cured properties.

### BACKGROUND OF THE INVENTION

1. Field of the Invention

The invention relates to the use of a powder composition comprising a (meth)acrylate polymer, a dispersant and a redispersion powder as a rheological additive in building material compositions, particularly in cement-containing building material compositions.

2. Background Art

The use of rheological additives in building material formulations is standard practice. They serve mainly to improve processing properties and water retention. Furthermore, such additives enable the property profile of the building material to be matched to a desired application profile (structure viscosity, thixotropy). Thickening additives used heretofore have been predominantly water-soluble polymers based on cellulose ethers, for example methylcellulose, hydroxyethylcellulose, methylhydroxyethylcellulose, hydroxypropylcellulose and carboxymethylcellulose. Although thickeners based on cellulose ethers are only used in small quantities, for example when used in cement-containing tile adhesives, these thickeners represent the second largest cost factor in cement-containing tile adhesives because of the complicated purification steps required for their production. There is therefore a need for rheological additives which can be obtained more inexpensively.

In many fields, cellulose ethers compete as thickeners with fully synthetic polymers such as polyurethane associative thickeners, polyacrylates, polyimines, polyamides, and also natural polymers such as agar-agar, tragacanth, carrageen, gum arabic, alginates, starch, gelatin and pectin. However, these alternatives are not satisfactory in building material compositions, particularly cement-containing systems, which have a high pH and a high electrolyte content. In these applications, there have thus far been no alternatives to cellulose ethers which yield processing behavior which is even close to acceptable.

EP-A 504870 discloses a thickener combination for building products which comprises natural polymers such as cellulose ethers together with salts of crosslinked polyacrylates optionally grafted with starch (known as superabsorbents) and dispersants based on formaldehyde-sulfonic acid condensation products.

WO-A 99/62838 describes cement mixtures comprising an additive combination of lignosulfonate and a copolymer of (meth)acrylic acid, (meth)acrylic esters and hydroxyalkyl (meth)acrylates for improving the sedimentation tendency of the cement compositions. GB-A 2279655 proposes adding an aqueous solution of an acrylic acid-methyl methacrylate copolymer and lignosulfonate to cement compositions to improve the flowability and the sedimentation behavior.

U.S. Pat. No. 6,165,262 describes the addition of pulverulent methyl acrylate-(meth)acrylic acid copolymers together with “water-reducing agents” such as lignosulfonate to cement compositions.

### SUMMARY OF THE INVENTION

It is an object of the invention to develop an additive, in particular for cement-containing building material compositions, which gives a thickening action without having an adverse effect on the processing properties or on the mechanical strength of the cured materials.

### DETAILED DESCRIPTION OF THE PREFERRED EMBODIMENTS

The invention provides for the use of a powder composition as a rheological additive in cement-containing or cement-free, substantially inorganic building material compositions, wherein the powder composition comprises a) a copolymer of (meth)acrylic acid and (meth)acrylic ester(s), b) a dispersant, and c) a polymer powder which is redispersible in water.

Suitable copolymers a) comprise copolymers of acrylic and/or methacrylic acid with methacrylic esters and acrylic esters of alcohols having from 1 to 25 carbon atoms or of alcohols containing (poly)oxyalkylene units. Preferred methacrylic esters and acrylic esters are methyl acrylate, methyl methacrylate, ethyl acrylate, ethyl methacrylate, propyl acrylate, propyl methacrylate, n-butyl acrylate, n-butyl methacrylate, t-butyl acrylate, t-butyl methacrylate, and 2-ethylhexyl acrylate. Also preferred are esters of acrylic acid and methacrylic acid with (poly)oxyalkylene alcohols containing from 1 to 50 oxyalkylene units which each have from 2 to 8 carbon atoms, in particular polyoxyethylene, polyoxypropylene and polyoxyethylene/polyoxypropylene radicals each containing from 1 to 20 oxyalkylene units.

The composition of the copolymers a) is selected such that the copolymers are water-soluble. In this context, water-soluble means that the solubility under standard conditions is at least 10 g of copolymer a) in 1000 g of water. Preferred copolymers comprise from 30 to 85% by weight, preferably from 40 to 70% by weight, of (meth)acrylic esters and from 15 to 70% by weight, preferably from 30 to 60% by weight, of acrylic acid and/or methacrylic acid, in each case based on the total weight of the copolymer. The molecular weight M_{w} (weight average) of the copolymer a) is greater than 20,000, preferably from 25,000 to 500,000, and more preferably from 50,000 to 350,000.

The copolymers a) can be prepared in a known manner, for example by means of solution polymerization, suspension polymerization, or emulsion polymerization. The polymers are subsequently dried by customary methods, for example by spray drying.

Suitable dispersants b) include all commercial dispersants such as lignosulfonates, polycarboxylates, aminosulfonic acids, naphthalenesulfonic acid-formaldehyde condensates, melaminesulfonic acid-formaldehyde condensates and hydroxycarboxylic acids, and their metal salts, for example their alkali metal salts and alkaline earth metal salts.

Suitable polymer powders which are redispersible in water c) include those based on one or more monomers selected from the group consisting of vinyl esters of unbranched or branched alkylcarboxylic acids having from 1 to 15 carbon atoms, methacrylic esters and acrylic esters of alcohols having from 1 to 10 carbon atoms, vinylaromatics, olefins, dienes and vinyl halides. It is also possible to use mixtures of the polymers mentioned.

The polymers may additionally contain from 0.1 to 10% by weight, based on the total weight of the polymer, of functional comonomer units such as ethylenically unsaturated carboxamides, e.g., (meth)acrylamide; ethylenically unsaturated sulfonic acids and their salts, preferably vinylsulfonic acid; multiply ethylenically unsaturated comonomers, for example divinyl adipate, diallyl maleate, allyl methacrylate or triallyl cyanurate; and/or N-methylol(meth)acrylamide and their ethers, for example their isobutoxy or n-butoxy ethers.

As polymers, preference is also given to those indicated below, where the percentages by weight, together with the proportion of functional comonomer units, if applicable, total up to 100% by weight. It should be noted that the redispersible polymers, while dispersible in water, unlike the copolymers a), are substantially insoluble.

From among the vinyl ester polymers, preference is given to vinyl acetate polymers; vinyl acetate-ethylene copolymers having an ethylene content of from 1 to 60% by weight; vinyl ester-ethylene-vinyl chloride copolymers having an ethylene content of from 1 to 40% by weight and a vinyl chloride content of from 20 to 90% by weight; vinyl acetate copolymers containing from 1 to 50% by weight of one or more copolymerizable vinyl esters such as vinyl laurate, vinyl pivalate, vinyl esters of alpha-branched carboxylic acids, in particular vinyl esters of Versatic acid (VeoVa9^{R}, VeoVa10^{R}, VeoVa11^{R}), and which may optionally contain from 1 to 40% by weight of ethylene; vinyl acetate-acrylic ester copolymers containing from 1 to 60% by weight of acrylic ester, in particular n-butyl acrylate or 2-ethylhexyl acrylate, which may optionally contain from 1 to 40% by weight of ethylene.

As(meth)acrylic ester polymers, preference is given to polymers of n-butyl acrylate and 2-ethylhexyl acrylate; copolymers of methyl methacrylate with n-butyl acrylate and/or 2-ethylhexyl acrylate; and copolymers of methyl methacrylate with 1,3-butadiene. With regard to vinyl chloride polymers, preference is given, apart from the abovementioned vinyl ester-vinyl chloride-ethylene copolymers, to vinyl chloride-ethylene copolymers and vinyl chloride-acrylate copolymers.

As styrene polymers, preference is given to styrene-butadiene copolymers and styrene-acrylic ester copolymers, e.g., styrene-n-butyl acrylate or styrene-2-ethylhexyl acrylate copolymers having a styrene content of from 10 to 70% by weight, respectively.

The ratios of the components of the pulverulent additive are from 10 to 100 parts by weight of component a), from 0.1 to 50 parts by weight of component b) and from 50 to 5000 parts by weight of component c). Preference is given to from 75 to 95 parts by weight of component a), from 5 to 25 parts by weight of component b) and from 100 to 400 parts by weight of component c).

To modify the cement-containing or cement-free compositions, the rheological additive can be added as a powder mixture. However, the components a), b) and c) can also be added individually. If a mixture is used, it can be prepared by adding the dispersant b) before or during drying in the preparation of the copolymer a) and mixing in the redispersion powder c) in a separate mixing step. However, the dispersant b) can also be mixed in using a separate mixing step. Particular preference is given to mixing the components a) and b) together with the aqueous dispersion on which the redispersion powder c) is based and subsequently drying the mixture, for example by spray drying.

The powder composition is suitable as rheological additive in hydraulically setting, cement-containing and cement-free (i.e., compositions containing CaSO₄ or lime). The powder composition is preferably used as a rheological additive in dry mortars. Particular preference is given to its use in dry mortars for building adhesives such as tile adhesives and adhesives for bonding thermal insulation boards and acoustic insulation boards. Further particularly preferred uses are in dry mortars for reinforcing compositions for composite thermal insulation systems, for knifing fillers, sealing slurries and plasters and renders. Preference is also given to use in gypsum compositions such as gypsum renders (plasters) and gypsum troweling compounds.

Typical formulations for dry mortars comprise from 5 to 80 parts by weight of hydraulic binder, preferably cement or plaster of Paris or lime; from 5 to 80 parts by weight of fillers such as quartz sand, calcium carbonate, aluminum silicates, talc or mica; from 0.1 to 1 part by weight of the (meth)acrylate copolymer a); from 0.001 to 0.5 part by weight of the dispersant b); from 0.5 to 50 parts by weight of the redispersion powder c); and also, if desired, further additives.

Examples of further additives are accelerators, retarders, fibrous fillers such as cellulose fibers, mineral fibers, and polymer fibers; antifoams; waterproofing agents; air pore formers; and optionally, further thickeners such as cellulose ethers, polyurethane associative thickeners, polyimines, polyamides, agar-agar, tragacanth, carrageen, gum arabic, alginates, starch, gelatin, and pectin.

Rheological additives based on (meth)acrylate polymers have been employed in cement-containing dry mortars thus far only with a significant decrease in quality, as reflected, for example, by unsatisfactory anti-flow properties and cement setting behavior, leading to unsatisfactory processing properties such as poor wetting of the substrate by the cement-containing compositions and inadequate plasticity of the cement-containing tile adhesive. The rheological additive combination of subject the invention makes it possible to obtain rheological additives based on (meth)acrylate polymers which, in contrast to (meth)acrylate-based rheological additives known hitherto, lead to cement-containing compositions which process very well and have excellent mechanical properties.

The following examples illustrate the invention:

### EXAMPLE 1

In a two liter reaction vessel equipped with reflux condenser, stirrer and feed vessel, 0.43 g of a 20% strength aqueous Melon solution were dissolved in 580 ml of water at 20° C. The solution was subsequently heated to 80° C. When a temperature of 50° C. had been reached, 5% by weight of an emulsion comprising 518 ml of water, 43 g of a 30% strength aqueous solution of poly(oxyethylene)isotridecyl sulfate, 403 g of methacrylic acid, 86.3 g of butyl acrylate and 388.3 g of ethyl acrylate were added while stirring to this solution. The emulsion was admixed with 2.6 g of ammonium persulfate when the temperature reached 80° C. 10 minutes after commencement of the reaction, a solution comprising 1.73 g of ammonium persulfate and 118 g of water was metered in over a period of 6 hours and the remaining monomer preemulsion was metered in over a period of 5 hours. After the metered additions were complete, the mixture was cooled to room temperature.

The polymer emulsion was mixed with 12% by weight of calcium lignosulfonate, based on polymer, and a redispersion powder (styrene-butyl acrylate copolymer) in a ratio of (a+b):(c) of 0.6:1.5 and spray dried.

### EXAMPLE 2

The procedure of Example 1 was repeated, but the polymer dispersion was spray dried without redispersion powder.

### EXAMPLE 3

The procedure of Example 1 was repeated using acrylic acid in place of methacrylic acid.

### EXAMPLE 4

The procedure of Example 1 was repeated using 2-ethylhexyl acrylate in place of butyl acrylate. The polymer emulsion was mixed with 12% by weight of calcium lignosulfonate, based on polymer, before spray drying.

### EXAMPLE 5

The procedure of Example 1 was repeated using 8% by weight of melaminesulfonic acid-formaldehyde condensate, based on polymer a), in place of 12% by weight of calcium lignosulfonate.

### COMPARATIVE EXAMPLE 1

The procedure of Example 1 was repeated but the polymer emulsion was dried without calcium lignosulfonate.

### COMPARATIVE EXAMPLE 2

The procedure of Example 2 was repeated but the polymer emulsion was dried without calcium lignosulfonate.

### COMPARATIVE EXAMPLE 3

The procedure of Example 3 was repeated, but the polymer emulsion was dried without calcium lignosulfonate.

### COMPARATIVE EXAMPLE 4

The procedure of Example 4 was repeated, but the polymer emulsion was dried without calcium lignosulfonate.

### COMPARATIVE EXAMPLE 5

The procedure of Example 2 was repeated, but no redispersion powder c) was used in the dry mortar formulation.

The powders comprising the components a) and b) obtained as described in Example 2 and Comparative Examples 2 and 5 were added together with the redispersion powder component c) to the following dry mortar mixture.

Testing of the powder compositions was carried out in the following formulation:

55.2 parts by weight of quartz sand No.9a (0.1-0.4 mm),

43.0 parts by weight of cement 42.5 (Rohrdorfer),

1.5 parts by weight of redispersion powder c) (styrene-butyl acrylate),

0.6 part by weight of powder mixture a)+b).

The dry mixture was admixed with the amount of water indicated in Table 1, the mixture was allowed to stand for 5 minutes and was then subjected to testing.

Test methods:

The test results are summarized in Table 1.

Determination of the Plasticity (PL):

The plasticity of the mixture was determined qualitatively by visual assessment. The mixture was given a grade on the scale from 1 to 6, with grade 1 representing the optimum.

Determination of Wetting (WE):

Wetting of a tile during application of the mortar was determined qualitatively by visual assessment. The mixture was given a grade on the scale from 1 to 6, with grade 1 representing the optimum.

Determination of Bridge Formation (BF):

Bridge formation was determined qualitatively by visual assessment. The mixture was given a grade on the scale from 1 to 6, with grade 1 representing the optimum.

Determination of After-thickening (AT):

After-thickening (viscosity increase) was determined qualitatively by visual assessment one hour after preparation of the tile adhesive. The mixture was given a grade on the scale from 1 to 6, with grade 1 representing the optimum.

Determination of Bonding Area (BA):

The bonding area was determined after 60 minutes on a tile (5×5 cm) which had been laid in the mortar after 10 minutes by measuring the wetting of the reverse side of the tile by mortar.

Determination of the Slippage Resistance (SR):

For the slippage test, a laid tile (15×15 cm) was loaded vertically from above with a particular weight for 30 seconds in each case.

Determination of the Redispersibility (RD):

The redispersibility was determined by measurement of the particle size distribution using a particle size analyzer from Coulter and comparison of the distribution of the starting dispersion with the distribution of the redispersed powder. 50% strength aqueous dispersions were prepared in each case and the particle size distribution of the redispersion was determined 30 seconds and 2 minutes after redispersion. Redispersion was evaluated qualitatively on a scale from 1 to 6, with 1 representing the optimum.

TABLE 1

| | | | | | | | RD 2 | BA | |
|---|---|---|---|---|---|---|---|---|---|
| Ex. | H₂O [g] | PL | WE | BF | AT | RD 30 s | min | [%] | SR [g] |
| Ex. 1 | 30.1 | 1 | 2 | 2.5 | 2 | 2 | 1 | 80 | 1000 |
| Ex. 2 | 30.0 | 2 | 2.5 | 2.5 | 3 | 4 | 2 | 80 | 1000 |
| Ex. 3 | 27.4 | 1 | 2.5 | 2 | 2.5 | 2 | 1 | 85 | 800 |
| Ex. 4 | 27.4 | 1 | 2 | 2 | 2 | 2 | 1 | 90 | 1000 |
| Ex. 5 | 30.8 | 1 | 2 | 2.5 | 1.5 | 1.5 | 1 | 95 | 800 |
| C.Ex.1 | 30.1 | 4 | 4 | 3.5 | 6 | 4 | 2 | 70 | 600 |
| C.Ex.2 | 30.0 | 4 | 4 | 3.5 | 6 | 5 | 4 | 70 | 600 |
| C.Ex.3 | 28.1 | 3 | 3.5 | 3 | 5 | 2 | 1 | 60 | 400 |
| C.Ex.4 | 27.4 | 4 | 4.5 | 3.5 | 5 | 4 | 2 | 65 | 800 |
| C.Ex.5 | 28.0 | 3 | 2.5 | 3 | 5 | — | — | 70 | 800 |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention. The terms “a” and “an” mean one or more unless indicated otherwise.

What is claimed is:

1. In a cement-containing or cement-free building material composition employing a rheological additive, the improvement comprising employing as a rheological additive, a pulverulent additive comprising:
a) a soluble copolymer of (meth)acrylic acid and (meth)acrylic esters,
b) a dispersant, and
c) a polymer powder which is redispersible in water.

2. The composition of claim 1, wherein the copolymer a) comprises units derived from acrylic acid and/or methacrylic acid, and from methacrylic esters and/or acrylic esters of alcohols having from 1 to 25 carbon atoms or esters of alcohols containing polyoxyalkylene units.

3. The composition of claim 2, wherein the copolymer a) comprises from 30 to 85% by weight of (meth)acrylic esters and from 15 to 70% by weight of acrylic acid and/or methacrylic acid, in each case based on the total weight of the copolymer.

4. The composition of claim 1, wherein the dispersant b) comprises one or more dispersants selected from the group consisting of lignosulfonates, polycarboxylates, aminosulfonic acids, naphthalenesulfonic acid-formaldehyde condensates, melaminesulfonic acid-formaldehyde condensates, hydroxycarboxylic acids, and metal salts thereof.

5. The composition of claim 1, wherein the polymer powder which is redispersible in water c) comprises a polymer powder based on one or more monomers selected from the group consisting of vinyl esters of unbranched or branched alkylcarboxylic acids having from 1 to 15 carbon atoms, methacrylic esters and acrylic esters of alcohols having from 1 to 10 carbon atoms, vinylaromatics, olefins, dienes, vinyl halides, and mixtures thereof.

6. The composition of claim 1, wherein the ratios of the components of the pulverulent additive are from 10 to 100 parts by weight of component a), from 0.1 to 50 parts by weight of component b) and from 50 to 5000 parts by weight of component c).

7. The composition of claim 1, wherein said building material composition is a dry mortar.

8. The composition of claim 7, wherein said dry mortar comprises a building adhesive, tile adhesive, or an adhesive for bonding thermal insulation boards and/or acoustic insulation boards.

9. The composition of claim 7, wherein said dry mortar comprises a reinforcing composition for composite thermal insulation systems, for knifing fillers, sealing slurries or plasters or renders.

10. The composition of claim 7, wherein the dry mortar comprises:
from 5 to 80 parts by weight of one or more hydraulic binders,
from 5 to 80 parts by weight of one or more fillers,
from 0.1 to 1 part by weight of a (meth)acrylate copolymer a),
from 0.001 to 0.5 part by weight of a dispersant b), and
from 0.5 to 50 parts by weight of a redispersion powder c).

11. The composition of claim 10, wherein the dry mortar comprises one or more of cement, plaster of Paris, or lime as said hydraulic binder.

12. In a building process where a cementitious or cement-free hydraulically setting building material is employed, the improvement comprising adding to said building material a pulverulent additive composition comprising:
a) a soluble copolymer of (meth)acrylic acid and (meth)acrylic esters,
b) a dispersant, and
c) a polymer powder which is redispersible in water.

13. The process of claim 12, wherein said components a), b), and c) are first blended together and subsequently added to said building material.

14. The process of claim 12, wherein said building material is a dry composition which sets after addition of water.

15. The process of claim 12, wherein said building material comprises a settable composition containing water, and said pulverulent additive is added to said settable composition containing water.

16. The process of claim 12, wherein the copolymer a) comprises units derived from acrylic acid and/or methacrylic acid, and methacrylic esters and/or acrylic esters of alcohols having from 1 to 25 carbon atoms or of alcohols containing polyoxyalkylene units.

17. The process of claim 12, wherein the copolymer a) comprises from 30 to 85% by weight of (meth)acrylic esters and from 15 to 70% by weight of acrylic acid and/or methacrylic acid, in each case based on the total weight of the copolymer.

18. The process of claim 12, wherein the dispersant b) comprises one or more dispersants selected from the group consisting of lignosulfonates, polycarboxylates, aminosulfonic acids, naphthalenesulfonic acid-formaldehyde condensates, melaminesulfonic acid-formaldehyde condensates, hydroxycarboxylic acids, and metal salts thereof.

19. The process of claim 1, wherein the polymer powder which is redispersible in water c) comprises a polymer powder based on one or more monomers selected from the group consisting of vinyl esters of unbranched or branched alkylcarboxylic acids having from 1 to 15 carbon atoms, methacrylic esters and acrylic esters of alcohols having from 1 to 10 carbon atoms, vinylaromatics, olefins, dienes, vinyl halides, and mixtures thereof.

20. The process of claim 12, wherein the dry mortar comprises:
from 5 to 80 parts by weight of one or more hydraulic binders,
from 5 to 80 parts by weight of one or more fillers,
from 0.1 to 1 part by weight of a (meth)acrylate copolymer a),
from 0.001 to 0.5 part by weight of a dispersant b), and
from 0.5 to 50 parts by weight of a redispersion powder c).
